(19) United States
(12) Patent Application Publication
(10) Pub. No.: US 2005/0249172 A1
(43) Pub. Date: Nov. 10, 2005

(54) System to provide direction information to mobile communication devices

(76) Inventor: Dale W. Malik, Dunwoody, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/840,867

(22) Filed: May 7, 2004

(51) Int. Cl. H04Q 7/24

(52) U.S. Cl. 370/338; 370/352

(57) ABSTRACT

Providing a user of a mobile communication device with direction information is disclosed. A router is adapted to receive a direction information query message for direction information for a destination telephone number from a mobile communication device. The router determines whether the destination telephone number is associated with a first telephony system or is associated with a second telephony network. A server and a gateway are connected to the router. The server is in communication with a database having directory information associated with the first telephony network stored therein. The gateway is in communication with the second telephony network. If the destination telephone number is associated with the first telephony network, the router provides the server with the direction information query message. If the destination telephone number is associated with the second telephony network, the router provides the gateway with the direction information query message. The mobile communication device includes logic embodied in a computer readable medium for generating a direction information query message, the direction information query message including a reference location indicator, and logic embodied in a computer readable medium for displaying direction information related to a destination telephone number.

### TECHNICAL FIELD

The present disclosure is generally related to mobile communication devices and, more particularly, is related to providing direction information to a mobile communication device.

### BACKGROUND

Today, many people carry mobile communication devices such as cell phones with them almost all the time. As people move from one location to another they sometimes get lost and need direction information. Today, a person having a mobile communication device will typically call a telephone that is located at the destination to request directions. This can cause great embarrassment and frustration to the lost person, especially when the telephone at the destination is busy.

Thus, what is sought is a method and system for providing users of the mobile communication devices with direction information.

### SUMMARY

Embodiments, among others, of the present disclosure provide a user of a mobile communication device with direction information related to a destination telephone number.

Briefly described, in architecture, one embodiment of a system, among others, can be implemented as follows. A router is adapted to receive a direction information query message requesting direction information for a destination telephone number from a mobile communication device. The router determines whether the destination telephone number is associated with a first telephony system or is associated with a second telephony network. A server and a gateway are connected to the router. The server is in communication with a database having directory information associated with the first telephony network stored therein. The gateway is in communication with the second telephony network. If the destination telephone number is associated with the first telephony network, the router provides the server with the direction information query message. If the destination telephone number is associated with the second telephony network, the router provides the gateway with the direction information query message.

Briefly described, in architecture, one embodiment of an apparatus, among others, can be implemented as follows. A mobile communication device includes logic embodied in a computer readable medium for generating a direction information query message, the direction information query message including a reference location indicator, and logic embodied in a computer readable medium for displaying direction information related to a destination telephone number.

Embodiments, among others, of the present disclosure can also be viewed as providing methods for providing a mobile communication device with direction information. In this regard, one embodiment of such a method, among others, can be broadly summarized by the following steps: receiving from the mobile communication device a direction information query message having a reference location indicator and a given telephone number; determining the direction information for the given telephone number; and transmitting a response message to the mobile communication device, the response message including the direction information.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a mobile communication system having a first service provider, a second service provider, a direction information service provider, and a mobile communication device.

FIG. 2A is a block diagram of the first service provider of FIG. 1.

FIG. 2B is a block diagram of subscriber reference location information.

FIG. 3A is a block diagram of the second service provider of FIG. 1.

FIG. 3B is a block diagram of the direction information service provider of FIG. 1.

FIG. 4 is a block diagram of the mobile communication device of FIG. 1.

FIG. 5 is a block diagram of a controller of the mobile communication device.

FIG. 6 is a block diagram of a message template.

FIG. 7 is a block diagram of a direction information query message.

FIG. 8 is an diagram of an exemplary response message.

FIG. 9 is a flow chart of steps taken at the mobile communication device related to getting and displaying direction information.

FIGS. 10A and 10B are flow charts of steps taken at the service provider related to providing direction information.

### DETAILED DESCRIPTION OF THE PREFERRED EMBODIMENTS

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present invention.

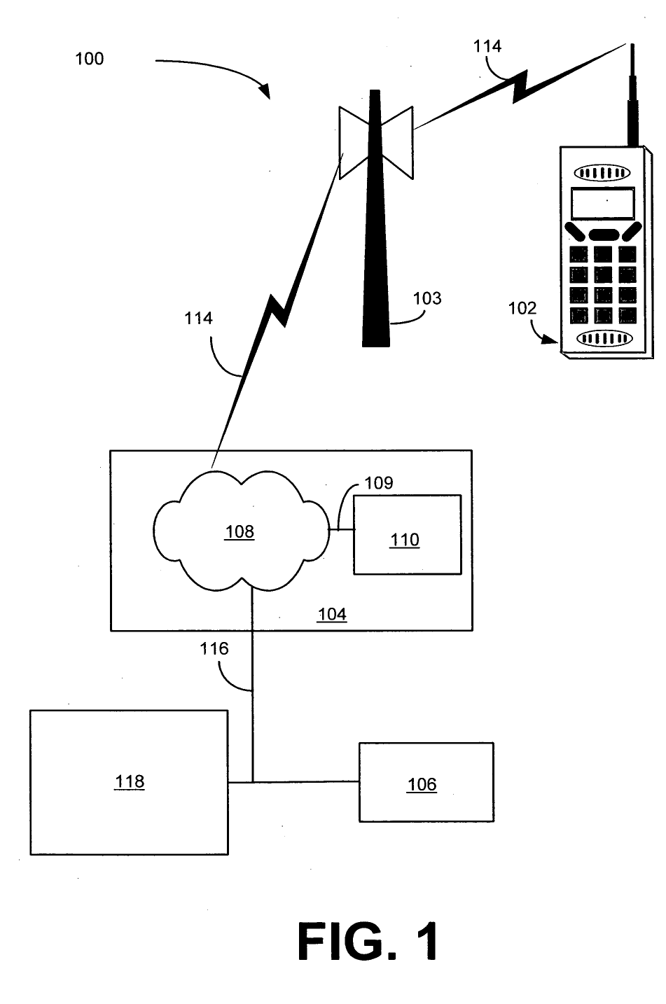

FIG. 1 is a block diagram of a mobile communication system 100. The mobile communication system 100 includes a mobile communication device 102 and a service provider 104. The mobile communication device 102 and service provider 104 communicate using signals that are carried over a wireless communication link 114. The signals carried over the wireless communication link 114 are relayed by one or more base stations 103. In some embodiments, the base stations 103 are in communication with the service provider 104 via a high bandwidth wired/optical communication link.

The service provider 104 is in communication with entities such as a second service provider 106 and a direction information service provider 118 via a communication link 116. The communication link 116 can be wired, optical, wireless, or other communication links known to those skilled in the art. The service provider 106 also provides directory information related to off-network telephone numbers.

The direction information service provider 118 provides directions to a destination from a starting location. Mapquest, for example, is one on many known direction information service providers.

The service provider 104 includes a short message service (SMS) network 108 and one or more central offices 110. The SMS network 108 and central office 110 communicate over a communication link 109. Those skilled in the art are familiar with SMS networks, which provide messaging services to and from the communication device 102, and therefore, the SMS network shall not be described in detail. SMS messages are generally short messages that are in the range of 120-200 characters.

The central office 110 includes various databases, computer systems, etc., for among other things, billing subscribers, processing/routing calls and messages, and providing services such as, but not limited to, providing direction information.

Sometimes, a user of the mobile communication device 102 needs directions to a given location, but the user might only have the telephone number of a telephone located at the given location. The user is now able to send a direction information query message to the service provider 104. The direction information query message will be explained in detail hereinbelow.

A direction information query message includes a reference location indicator and destination telephone number, which is a telephone number of a telephone located or associated with a destination. The reference location is a point chosen by the user. The service provider 104 or another entity determines the address associated with the destination telephone number and provides the destination address and the address of the reference location to the direction information service provider 118. The direction information service provider 118 provides the service provider 104 with directions from the reference location to the destination telephone number, and the service provider 104 then sends the directions to the mobile communication device 102. In one preferred embodiment, messages are communicated between the mobile communication device 102 and the service provider 104 using a protocol such as Short Message Service (SMS). However, the SMS protocol is only one non-limiting example of the type of protocol that can be used to communicate between the service provider 104 and the mobile communication device 102, and, in other preferred embodiments, other protocols, which are known to those skilled in the art, are used.

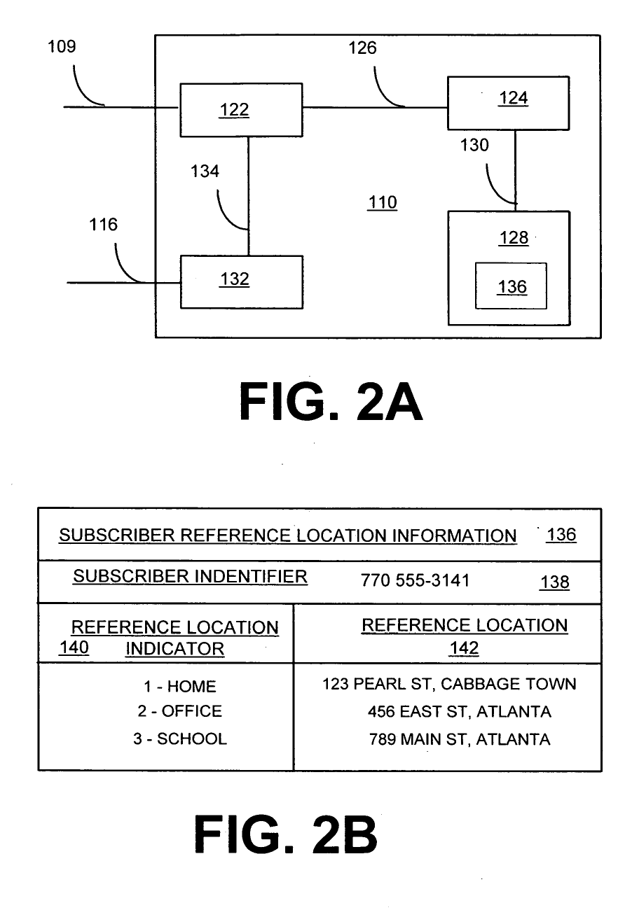

FIG. 2 is a block diagram illustrating additional selected components of the central office 110. The central office 110 includes at least a router 122 and a server 124, which are coupled together via a communication link 126. Among other things, the router 122 receives SMS messages from the mobile communication device 102 and routes the SMS messages. The central office 110 also includes a database 128 that is connected to the SMS server 124 by a communication link 130. The database 128 includes names, addresses, and telephone numbers of subscribers of the service provider 102. Preferably, the database 128 is a “structured query language” (SQL) capable database that can provide information in response to SQL calls, and in another preferred embodiment, the database 124 is adapted to be responsive to Light Directory Access Protocol (LDAP) queries.

The database 128 also includes subscriber reference location information 136, which is illustrated in FIG. 2B. The subscriber reference location information 136 includes a subscriber identifier 138, which in one embodiment is the telephone number of the mobile communication device 102. Each subscriber associates reference location indicators 140 with reference location 142. The reference location 142 for a given reference location indicator 140 is a physical address. Thus, “Home” is associated with the address 123 Pearl St, Cabbage Town. In the exemplary subscribe reference location information 136, the subscriber has provided three reference locations. The number of reference locations is arbitrary and three were shown merely for illustrative purposes.

In one embodiment, the user of the mobile communication device 102 can access the server 124 and/or the database 128 using a computer (not shown) over the internet (not shown) to input the addresses of reference locations. The user might also provide the addresses of the reference locations to an operator or may use messaging features of the mobile communication device 102.

The central office 110 also includes an e-mail gateway 132 that is coupled to the router 122 by a communication link 134. The e-mail gateway 132 is adapted to receive SMS messages from the router 122 and transmit e-mail messages over communication link 116. As those skilled in the art would understand, e-mail messages are only one form of messages that can transmitted over communication link 116, and in other preferred embodiments, other types of messages are received and transmitted over communication link 116.

The router 122 includes a look-up table for telephone numbers provided by the service provider 104. When the router 122 receives a direction information query message from the mobile communication device 102, the router 122 determines whether the direction information query message is an in-network or off-network message using the look-up tables. For the purposes of this disclosure, an in-network message is one in which the destination telephone number corresponds to a subscriber of the service provider 102. Whereas, an off-network direction information query message is one where the destination telephone number does not correspond to a subscriber of the service provider 102, and an off-network service provider is defined as a service provider other than the service provider 104. It is important to note that the mobile communication device 102 sends direction information query messages, and that it is the router that filters the received direction information query messages into in-network and off-network direction information query messages, i.e., there is no difference in the format between an off-network and in-network direction information query message.

When the router 122 receives a direction information query message that is an in-network direction information query message, the router 122 provides the direction information query message to the SMS server 124. When the router 122 receives an off-network direction information query message, the router 122 sends the direction information query message to the e-mail gateway 132.

As those skilled in the art would understand, the service provider 104 can respond to direction information query messages based upon different business models. For example, direction information look-up can be a premium service, bundled with selected services, a per use service, charged on a graduated fee basis, etc. The router 122 provides a billing system (not shown) of the service provider with billing information related to direction information query messages from the mobile communication device 102. Typically, the billing information from the router 122 to the billing system includes information regarding whether or not the direction information query message was an off-network or in-network direction information query message. The billing system then uses the information from the router 122 to bill or not bill the user of the mobile communication device 102.

When the SMS server 124 receives a direction information query message, the server 124 parses the direction information query message to find the telephone number included in the direction information query message. The server 124 then queries database 128. Typically, the query from the server 124 to the database 128 is performed using an SQL or an LDAP call that includes the telephone number. In response to receiving the SQL or LDAP call from the server 124, the database 128 sends the address that is associated with the destination telephone number to the server 124. The server 124 then generates a direction request message, which is provided to the e-mail gateway 128 via the router 122, and the e-mail gateway 128 transmits the direction request message to the direction information service provider 118 via communication link 116. The direction request message includes the destination address and the address of the reference location.

When the direction information query message is an off-network query, then the router 122 sends the message to the e-mail gateway 132. Among other things, the e-mail gateway 132 receives SMS messages from the router 122 and reformats the messages into e-mail messages. The e-mail gateway 132 includes look-up tables that the e-mail gateway 132 uses for, among other things, determining the e-mail address of the off-network service provider associated with the selected telephone number included in the off-network direction information query message. When the e-mail gateway receives an SMS message, the e-mail gateway determines an address for a recipient, i.e., the off-network service provider associated with the selected telephone number included in the off-network direction information query message. The e-mail gateway 132 then sends an e-mail message to the recipient over communication link 116. In one preferred embodiment, when the e-mail gateway 132 receives an off-network direction information query message, which includes both the selected telephone number and a reference location indicator, the e-mail gateway 132 parses the SMS message such that the e-mail that is sent to the off-network service provider associated with the selected telephone number does not include the reference location indicator.

The e-mail gateway 132 also receives e-mail messages from other service providers such as service provider 106 and the directory information service provider 118. When the e-mail gateway 132 receives a message from the service provider 106, which includes the destination address associated with a destination telephone number, the e-mail gateway 132 provides the information to the server 124 so that the server 124 can generate a direction request message for the direction information service provider 118. When the e-mail gateway 132 receives a message from the direction information service provider 118, the e-mail gateway 132 provides the directions to the server 124.

Once the server 124 has received the directions from the direction information service provider 118, the server 124 sends the directions in one or more response messages. In one embodiment, the server 124 sends a series of response messages, each of the messages having a portion of the directions. In this alternative embodiment, the first response message is sent automatically, but subsequent response messages are sent responsive to receiving a prompt from the user of the mobile communication device 102. In this manner, the mobile communication device is not sent more information than it can handle, and, in some situations, the user might not require the complete directions. The user can prompt the server 124 by sending a prompt message for another portion of the directions.

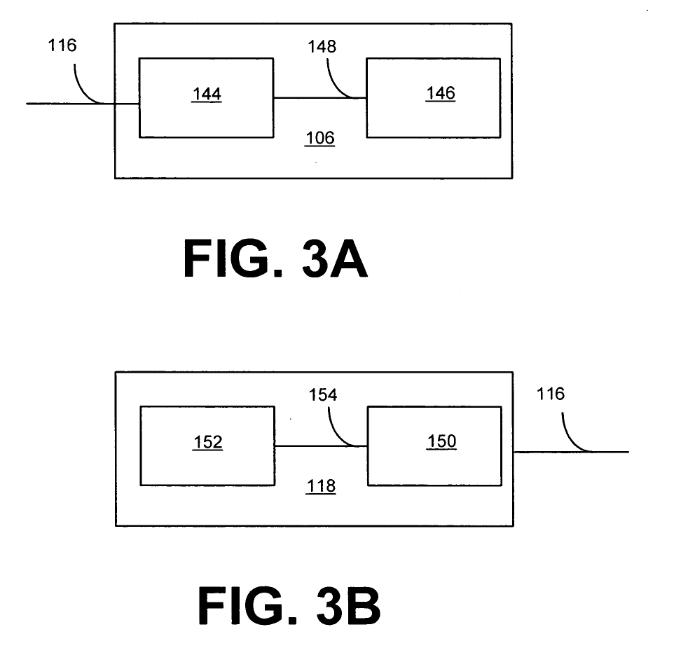

FIG. 3A is a block diagram illustrating selected components of the off-network service provider 106. Theservice provider 106 includes an e-mail response system 144 connected to a database 146 via a communication link 148. The e-mail response system 144 receives e-mails from the e-mail gateway 132 via communication link 116. When the e-mail response system 144 receives an e-mail, the e-mail response system 144 parses the e-mail to get the destination telephone number that was selected by the user of the mobile communication device 102. The e-mail response system 144 then sends a query, which is normally formatted in a protocol such as, but not limited to, signal system 7 (SS7) to the database 146. The database 146 provides the address that is associated with the telephone number to the e-mail response system 144. The e-mail response system 144 then sends a response e-mail message that includes the address to the e-mail gateway 132.

As those skilled in the art will recognize, if the telephone number that the subscriber selected was unpublished, then the queried database, either database 128 or database 146 does not provide the address. Instead, the appropriate database provides an indication that the address is unpublished. In either case, the user of the mobile communication device 102 would receive a response message indicating that the address was “unpublished,” or some other indication that the telephone number was unpublished/unlisted/unavailable.

FIG. 3B is a block diagram illustrating selected components of the direction information service provider 118, which includes an e-mail response system 150 connected to a server 152 via a communication link 154. The e-mail response system 150 receives e-mails from the e-mail gateway 132 via communication link 116. When the e-mail response system 150 receives an e-mail, the e-mail response system 150 parses the e-mail to get a destination address and a reference location. The e-mail response system 144 then sends the destination address and reference location to the server 152. The server 152 responds by providing the directions from the reference location to the destination address to the e-mail response system 150. The e-mail response system 150 then sends a response e-mail message that includes the directions to the e-mail gateway 132.

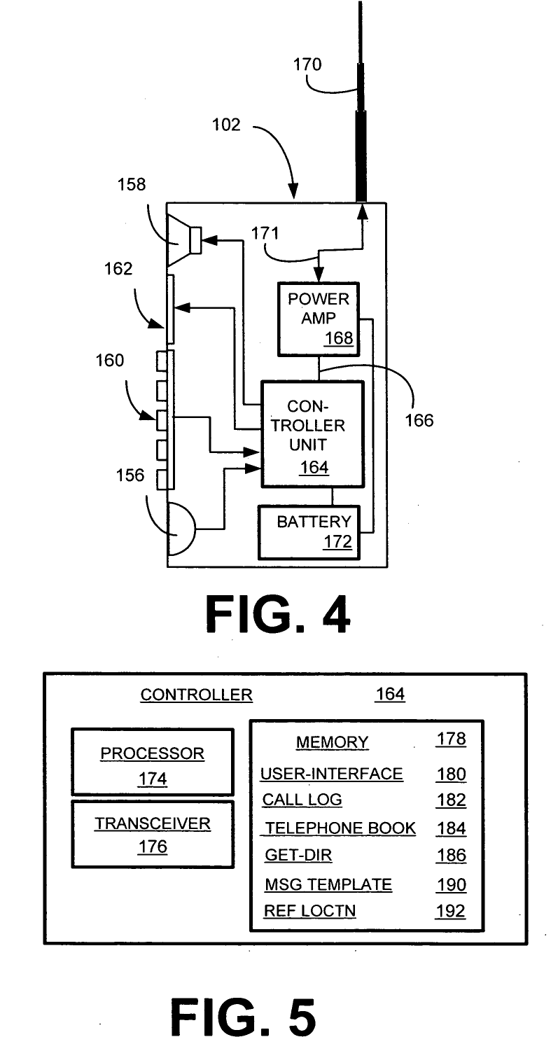

FIG. 4 is a block diagram of selected components of the mobile communication device 102. The mobile communication device 102 includes a microphone 156, a speaker 158, keys 160, and a display device 162. The microphone 156 converts audio energy into electrical signals and provides the electrical signals to a controller unit 164. The speaker 158 converts electrical signals from the controller unit 164 into audio signals. The keys 160 are actuated by the user of the mobile communication device 102 and enable the user to provide input to the controller 164. The user may also use the keys to, among other things, enter telephone numbers, write text of messages, enter names and control and select menu options.

The display device 162 is typically a liquid crystal display (LCD) or similar display. The display device 162 receives electrical signals from the controller unit 164 and provides graphical and textual information to the user.

The mobile communication device 102 also includes a power source 172. Non-limiting examples of power source 172 include conventional batteries, fuel cells and solar energy panels, and rechargeable batteries. The power source 172 provides electrical energy to the controller unit 164 and to a power amplifier 168.

Among other things, the controller unit 164 receives input from the keys 160, and from the microphone 156. The controller unit 164 also receives input from a power amplifier 168 via connection 166. The controller unit 164 provides output to the display device 162, the speaker 158, and the power amplifier 168. The controller unit also provides communication signals to the power amplifier 168 and receives signals from the power amplifier 168 via the connection 166.

The power amplifier 168 amplifies communication signals from the controller unit 164 and provides the amplified communication signals to an antenna 170 via connection 171. The antenna 170 also receives signals from the base station 103 and provides the signals to the controller unit 164 via the power amplifier 168.

FIG. 5 is a simplified block diagram of select components of the controller unit 164. The controller unit 164 includes a processor 174, a transceiver 176, and a memory 178. The transceiver 176 receives signals from the microphone 156. Typically, the transceiver 176 includes an analog-to-digital converter that converts the signals from the microphone 156 into digital signals. The digital signals are then provided to the power amplifier 168. The transceiver 176 also normally includes a digital-to-analog converter that receives digital signals from the base station 103 via the power amplifier 168 and converts the digital signals into analog signals, which are then provided to the speaker 158.

The memory 178 includes a user interface module 180, a call log 182, a telephone book 184, a get-direction module 186, a message template 190, and reference location indicators 192. The call log 182 includes tables of telephone numbers and other information. Generally the call log 182 includes, among other things, telephone numbers for dialed calls, telephone numbers of received calls, and telephone numbers of unanswered calls. Among other things, the get-direction module 186 includes logic for partially filling in the message template 190, for parsing a received message, and for displaying direction information. The telephone book 184 is a table of telephone numbers and names. The reference location indicators 192 correspond to the reference locations 142 given in the user's subscriber reference location information 136.

Preferred embodiments can be implemented in hardware, software, firmware, or a combination thereof In one preferred embodiment, the e-mail distribution/regulatory logic is implemented in software or firmware that is stored in a memory and that is executed by a suitable instruction execution system. If implemented in hardware, as in an alternative embodiment, the e-mail distribution/regulatory logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The processor 174 implements the user interface module 180 to provide, user interface functions to the user of the mobile communication device 102. In alternative embodiments, user interface functionality can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

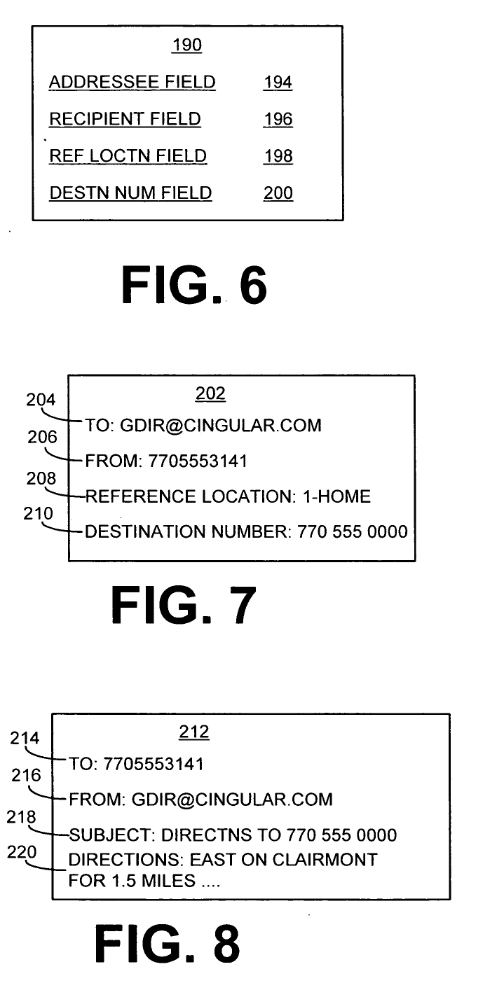

FIG. 6 illustrates the exemplary message template 190, which is stored in memory 178 and which is used for, among other things, communicating between the mobile communication device 102 and base station 103 and service providers and others. For the purposes of illustration, the message template 190 is described as an SMS message. The message template 190 includes an addressee field 194, a sender field 196, a reference location field 198, and a destination number field 200.

FIG. 7 illustrates an exemplary direction information query message 202. When the user selects “get direction” 186, the processor 174 generates a copy of the message template 190 and populates the fields 194 and 196 and 208, of the direction information query message 202. The addressee field 194 is populated with a unique address such as “user_name@domainname.” In this embodiment, the “user_name” is used to define a particular service offered by the recipient of the direction information query message 202. The “domainname” in the address corresponds to a name found by a domain name server. In the exemplary direction information query message illustrated in FIG. 7, the direction look-up service, which is provided by the service provider 104, is called “GDir”, and the service provider 104 is “Cingular”®.

The processor 174 populates the sender field 196 with an identifier of the mobile communication device 102. Typically, the identifier of the mobile communication device 102 is the telephone number of the mobile communication device, however, other identifiers can also be used. The identifier for the sender is unique to the mobile communication device 102 at least within the network established by the service provider 104.

Responsive to user input, the processor 174 populates the reference location field 208 with an indicator that corresponds to one of the reference locations stored in the database 128. The processor 174 also populates the destination number field with a destination telephone number. The user may select the destination telephone number from the call log 182 or from the telephone book 184 or the user may manually enter the destination telephone number using keys 160.

FIG. 8 illustrates an exemplary response message 212. As with the direction information query message 212, the response message 212 conforms to a predetermined message format, such as SMS. The response message 212 includes a recipient field 214, a sender field 216, a subject field 218, and a directions field 220. The recipient field 214 carries the telephone number of the mobile communication device 102. The sender field 196 of the response message 212 is populated with an address that identifies the message as being a response message. In this example, any message received by the mobile communication device 102 from the sender “GDIR@cingular.com” ® is a response message.

The subject field 218 of the response message 212 includes indicates that the message is related to directions to the destination telephone number. The directions field 220 carries some or all of the directions from the reference location to the destination location.

When the mobile communication device 102 receives a response message 212, the processor 174 reads and processes the message. The processor 174 identifies the message as being a response message using the information in the sender field 196. The content of the response message is formatted such that the processor 174 can read the content field 198 and parse the information contained therein. The content is parsed such that the processor 174 can read the telephone number and the “name” associated with the telephone number, or if the response message 212 indicated that the telephone number was unlisted, then the content is parsed such that the processor can read that the telephone number was unlisted.

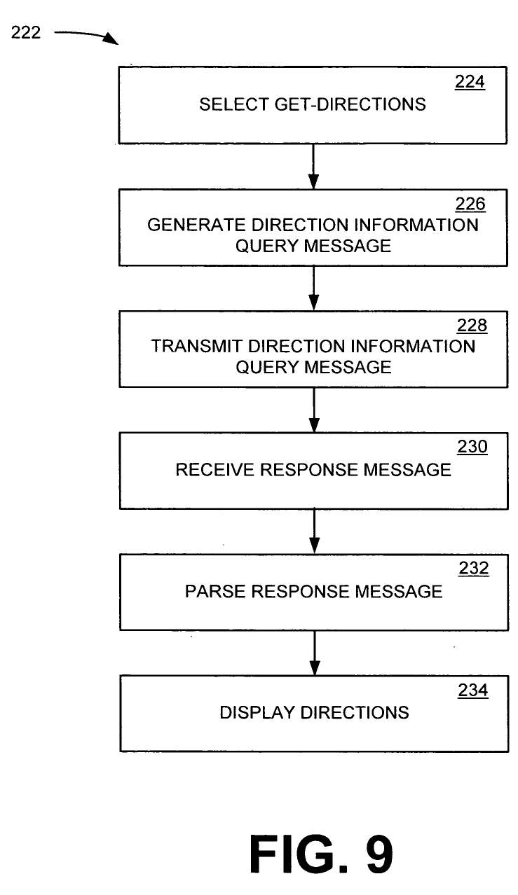

Exemplary steps 222, which are illustrated in FIG. 9, are implemented at the mobile communication device 102. The user interface 180 displays various menus to the user of the mobile communication device 102 on the display device 162. The user of the mobile communication device uses the keys 160 to input information and/or to select menu options so as to perform steps 222. In step 224, the user selects “get direction” 186 from a menu displayed on the display device 162. The “get direction” module 186 provides, among other things, a menu from which the user selects a reference location. The user selects a destination telephone number using the call log 182 or telephone book 184 or manually enters a destination telephone number.

In step 226, the mobile communication device 102 generates a direction information query message 202. The direction information query message 202 is addressed to the service provider such as the service provider 104 that responds to direction information query messages. The direction information query message includes a sender identifier such as the telephone number of the mobile communication device 102 and includes an indicator for a reference location and the destination telephone number or another indicator for the final destination. In step 228, the direction information query message is sent to the service provider 104.

In step 230, responsive to having sent the direction information query message 202, the mobile communication device 102 receives a response message 212. The response message 212 includes a sender field 216 that identifies the response message as having come from the service provider 104, a subject field 218, and a directions field 220.

In step 232, the mobile communication 102 reads the sender field 196 and determines that the response message 202 is an actual response message as opposed to other messages that the mobile communication device can also receive. The contents of the directions field 220 of the response message 212 is in a predetermined format, which enables the mobile communication device 102 to parse the content therein.

In step 234, the mobile communication device 102 displays available direction information to the user of the mobile communication device 102. The displayed direction information includes part or all of the directions from the reference location to the destination telephone number. However, if the destination telephone number is unlisted, then the displayed information might be something to the effect “unlisted”, “unavailable”, “unpublished”, etc.

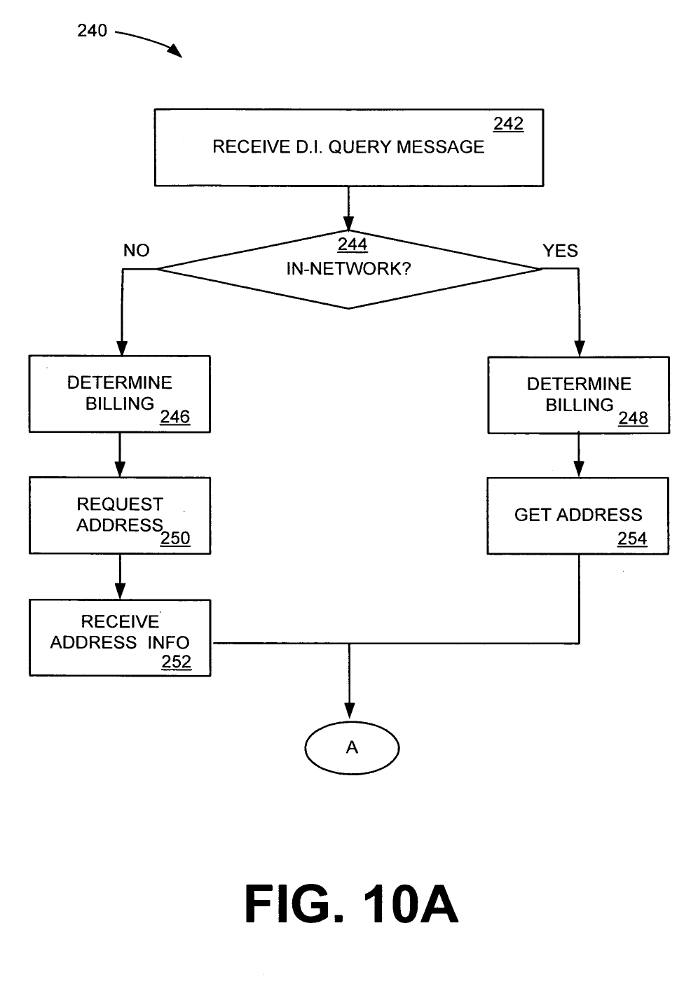

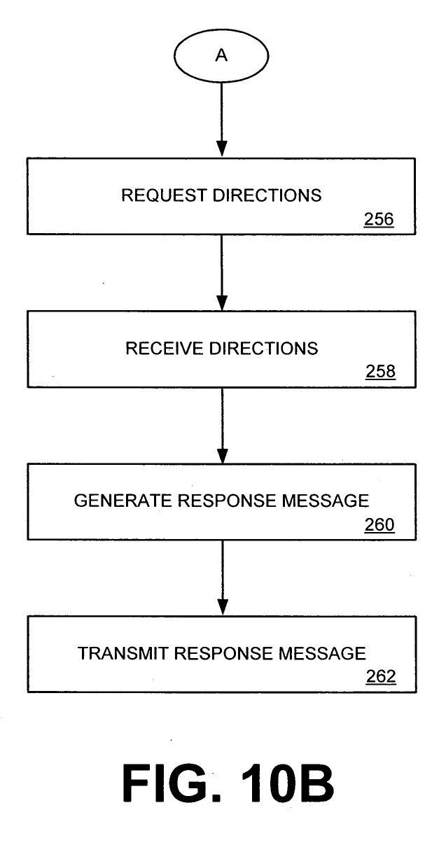

Exemplary steps 240, which are illustrated in FIGS. 10A and 10B are implemented by the service provider 104. In step 242, the service provider 104 receives a direction information query message 202.

In step 244, the service provider 104 determines whether the direction information query message is for an off-network or in-network telephone number. In steps 246 and 248 the service provider 104 determines billing charges for the direction information query message. The billing charges can depend upon whether the query is for an off-network telephone number or in-network telephone number, the number of direction information look-up request by the mobile communication device 102, whether the mobile communication device is given free direction information look-up, etc.

In an alternative embodiment, the service provider 104 sends the mobile communication device 102 a message informing the user of how much he or she will be charged for looking up the requested telephone number. The user may then send a message that confirms that he or she accepts the charge. Once the service provider 104 has received the confirmation message from the user, the process continues. Otherwise, the service provider 104 ignores the direction information query message.

In step 250, responsive to the direction information query message being an off-network look-up, the service provider 104 requests address information from another service provider such as service provider 106 or a reverse look-up service provider. The other service provider has a database that associates the destination telephone number with an address. In one preferred embodiment, the service provider 104 sends the other service provider an e-mail requesting the address of the destination telephone number. The other service provider looks-up the address, and in step 252, the other service provider provides the address in a return e-mail.

In step 254, the service provider 104 gets the address information from the database 128.

In step 256, the service provider 104 requests the directions from the direction information service provider 118, and in step 258, the service provider 104 receives the directions from the direction information service provider.

In step 260, a response message that includes the directions to the destination telephone number is generated, and in step 262, the response message is transmitted to the mobile communication device 102. Generally, the response message only includes directions if the destination telephone number included in the direction information query was not unlisted or otherwise restricted.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present invention.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. For example, in one embodiment, the user of the mobile communication device can request reverse directions, i.e., directions from the destination address to the address of the reference location. All such modifications and variations are intended to be included herein within the scope of this disclosure and the present disclosure and protected by the following claims.

1. A method of providing a mobile communication device with direction information, the method comprising the steps of:
receiving from the mobile communication device a direction information query message having a reference location indicator and a given telephone number;
determining the direction information for the given telephone number; and
transmitting a response message to the mobile communication device, the response message including the direction information.

2. The method of claim 1, further including the steps of:
determining whether the given number is associated with a first telephony network;
responsive to determining that the given number is not associated with the first telephony network, requesting off-network directory information from a database associated with a second telephony network.

3. The method of claim 2, further including the step of:
transmitting the request for off-network direction information in an email.

4. The method of claim 2, further including the step of:
responsive to determining that the given number is not associated with the first telephony network, charging the mobile communication device for the off-network directory information.

5. The method of claim 2, further including the step of:
receiving the off-network directory information, wherein the off-network information direction information is included in the response message.

6. The method of claim 1, wherein the step of determining includes querying a database using the given telephone number.

7. The method of claim 1, wherein the direction information query message conforms to a Short Message Service (SMS) protocol, and wherein the response message conforms to a Short Message Service (SMS) protocol.

8. The method of claim 1, further including the steps of:
using the reference location indicator to determine the a specific location; and
determining a destination address.

9. The method of claim 8, further including the steps of:
using the specific location information and the destination address to determine directions from the specific location information and the destination address; and
providing the direction information in one or more messages sent to the mobile communication device.

10. The method of claim 1, further including the step of:
charging the mobile communication device for determining the direction information.

11. A method of providing a user of a mobile communication device with direction information, the method comprising the steps of:
transmitting a direction information query message having a destination telephone number and a reference location indicator;
receiving a second message having the direction information therein;
displaying to the user at least a portion of the direction information;
selecting the destination telephone number from a log of received calls; and
manually inputting the destination telephone number.

12. The method of claim 11, wherein the direction information query message conforms to a Short Message Service (SMS) protocol, and wherein the second message conforms to a Short Message Service (SMS) protocol.

13. The method of claim 11, further including the steps of:
receiving user input; and
responsive to the user input, automatically populating a plurality of fields included in the direction information query message, wherein the plurality of fields includes a reference location field that carries the reference location indicator, wherein the plurality of fields includes a recipient field that is associated with a service provider, wherein the service provider provides the mobile communication device with the direction information, and wherein the plurality of fields includes a sender field that carries information associated with the mobile communication device.

14. The method of claim 11, further including the steps of:
determining that the second message is a response message; and
responsive to the second message being a response message; displaying at least a portion of the direction information.

15. A system for providing direction information to a user of a mobile communication device, wherein the mobile communication device is associated with a first telephony network, the system comprising:
a router adapted to receive a direction information query message from the mobile communication device, the direction information query message including a destination telephone number, wherein responsive to the router receiving the direction information query message the router determines whether the destination telephone number is associated with the first telephony system or is associated with a second telephony network;
a server connected to the router, the server in communication with a database having direction information associated with the first telephony network stored therein;
a gateway in communication with the router and in communication with the second telephony network; and
wherein responsive to the destination telephone number being associated with the first telephony network, the router provides the server with the direction information query message, and wherein responsive to the destination telephone number being associated with the second telephony network, the router provides the gateway with the direction information query message.

16. The system of claim 15, wherein the gateway receives the direction information query message from the router and sends an email message to a directory look-up service provider associated with the second telephony system requesting the directory information of the destination telephone number.

17. The system of claim 16, wherein the gateway receives the direction information of the destination telephone number and provides the direction information to the mobile communication device via the router.

18. The system of claim 15, wherein the server receives the direction information query message from the router and parses the direction information query message to find a key and queries the database using the key, and responsive to the query, the database provides the server with the address of the destination telephone number, and the server uses the address of the destination telephone number and the reference location indicator to determine the direction information.

19. The system of claim 18, wherein the query to the database is a structured query language (SQL) query.

20. The system of claim 15, wherein the direction information query message conforms to a Short Message Service (SMS) protocol, and wherein the router provides a response message to the mobile communication device, the response message having the direction information included therein, and the response message conforming to a Short Message Service (SMS) protocol.

21. The system of claim 15, further including:
a billing system in communication with the router, the billing system adapted to charge for looking up the direction information.

22. A mobile communication device, the mobile communication device comprising:
logic embodied in a computer readable medium for generating a direction information query message, the direction information query message including a reference location indicator; and
logic embodied in a computer readable medium for displaying direction information related to a destination telephone number, wherein the destination information is included in a response message.

23. The mobile communication device of claim 22, wherein the logic for generating the direction information query message further includes:
logic embodied in a computer readable medium for addressing the direction information query message to a predetermined recipient.

24. The mobile communication device of claim 22, wherein the logic for generating the direction information query message further includes:
logic embodied in a computer readable medium for including a destination telephone number in the direction information query message.
